(19) United States
(12) Patent Application Publication
(10) Pub. No.: US 2014/0310133 A1
(43) Pub. Date: Oct. 16, 2014

(54) DYNAMIC REVIEW AND APPROVAL PROCESS

(71) Applicant: INTERNATIONAL BUSINESS MACHINES CORPORATION, Armonk, NY (US)

(72) Inventors: RICHARD G. BEDNAR, Johnson City, NY (US); Amelia C. Carruth, Olympia, WA (US); Glenn C. Godoy, Endwell, NY (US); Mark Kemp, Normalville, PA (US); Gautam Majumdar, Wappingers Falls, NY (US); Russell E. Parks, Marlboro, NY (US)

(73) Assignee: International Business Machines Corporation, Armonk, NY (US)

(21) Appl. No.: 13/862,385

(22) Filed: Apr. 13, 2013

(51) Int. Cl. G06Q 30/06

(52) U.S. Cl. CPC G06Q 30/0637
USPC 705/26.82

(57) ABSTRACT

A dynamic review and approval process includes determining a minimum approval limit and constructing an approver list for procurement of one of goods and services. The approver list comprises a plurality of approvers, each approver having an approval limit that at least meets the minimum approval limit. The process includes removing one or more approvers who are unavailable and utilizing delegates for unavailable approvers. Processing approvals comprises notifying a first approver of the need for review and approval, receiving an approval or unapproval from the first approver, and repeating the steps of notifying and receiving for the remaining approvers on the approver list. An approval or unapproval from an approver not on the approver list is received and it is determined if the approval process is complete. It indicated to a user if the approval process is complete, otherwise the steps of notifying and receiving are repeated.

### BACKGROUND

The present invention relates generally to systems for acquiring goods and services in a business environment, and more particularly, to a dynamic review and approval processes for acquiring approvals for procurement in a business environment.

There are many different types of goods and services that businesses may need in order to function properly. Communications services such as telephone services, long distance carriers, cellular telephone providers, and Internet services are typically important to companies of all sizes. Businesses may additionally engage other services such as computer and server maintenance, marketing and public relations, legal services, and mass printing and mailing services. Necessary goods can range from raw materials for manufacturing concerns, to the supplies regularly used in offices by businesses and other organizations.

In large corporations, a central purchasing department often handles the process of goods and services procurement. The central purchasing department is often responsible for finding prospective vendors to provide the goods or services needed. The purchasing department typically compares the services of vendors with those of their competitors, and then attempts to negotiate procurement of the services under the best possible terms. Purchasing agents and managers often have the authority to enter into procurement contracts with vendors, as long as the contracts meet the standards and regulations of the corporation. When a purchasing department is part of the corporate structure, other departments within the corporation submit their requests for new goods or services to a purchasing agent rather than seeking services on their own.

A known method and system for introducing a new project initiative into a business involves a computer system that receives project information from a requesting party and lays out required elements for successful project implementation in a systematic series of stages, milestones and checklists. A variety of milestones and checklists are completed for each stage and relevant documentation is electronically attached and referenced in the computer system. A stage approver is then electronically notified by the computer system that a stage approval needs to be made. In response to this notice, the stage approver reviews the collected information and makes a determination as to whether the project should advance to the next stage. If a stage approval is received, the requesting party is electronically notified and the various milestones and checklists corresponding to the next stage are undertaken. By progressing through all stages, information is shared and a system of record for new project initiative introductions is created which may be searched and referenced. A disadvantage of this known method and system is that it only provides for a single approval at the completion of each stage, in the approval process. The method and system does not allow for out of order approvals or for uninvited approvers, and thus comprises a relatively static approval process.

Another known procurement system comprises a networked computer system for acquiring prequalification information and distributing the prequalification information to one or more participants for approval. This system includes a network-based server that establishes electronic communication between the server and a first device through the network and receives business information for a first organization from the first device through the network. The business information includes a plurality of data items relating to the first organization. A second organization submits a request for a subset of data items and one or more of the requested data items are displayed to the second organization. The system receives an approval of each displayed data item from the second organization and generates a final aggregated approval document including each of the approved data items. The system then receives a final approval of the final aggregated approval document from the second organization and stores a prequalification indication indicating that the first organization is approved to bid on construction projects for the second organization. A disadvantage of this system is that approvals are performed on individual data items and then aggregated into the prequalification. The final approval of the aggregate serves as the indicator for overall prequalification. The disclosed system does not allow for out of order approvals or parallel approvals.

### BRIEF SUMMARY

In one general embodiment, a method includes determining a minimum approval limit and constructing an approver list for procurement of one of goods and services. The approver list comprises a plurality of approvers, each approver having an approval limit that at least meets the minimum approval limit, and removing one or more approvers from the approver list who are unavailable and utilizing delegates for unavailable approvers. Processing approvals comprises notifying a first approver from the approver list of the need for review and approval, receiving an approval or unapproval from the first approver, and repeating the steps of notifying and receiving for the remaining approvers on the approver list. An approval or unapproval from an approver not on the approver list is received and it is determined if the approval process is complete. If the approval process is complete, then indicating to a user that the approval process is complete, otherwise repeating the steps of notifying and receiving for the remaining approvers on the approver list.

In another general embodiment a non-transitory computer program product comprises a computer usable medium having computer usable program code embodied therewith. The computer usable program code comprises computer usable program code configured to receive and process an approval request for procurement of one of goods and services. The computer usable program code comprises computer usable program code configured to determine a minimum approval limit, computer usable program code configured to construct an initial approver list. The approver list comprises a plurality of approvers, with each approver having an approval limit that at least meets the minimum approval limit. The computer usable program code further comprises computer usable program code configured to determine availability of approvers on the approver list and utilize delegates for unavailable approvers and computer usable program code configured to process approvals. The computer usable program code configured to process approvals comprises computer usable program code configured to notify a first approver from the approver list of the need for review and approval, computer usable program code configured to receive an approval or unapproval from the first approver, and computer usable program code configured to repeat the steps of notify and receive for the remaining approvers in the approver list. The computer usable program code further comprises computer usable program code configured to receive an approval or unapproval from an approver not on the approver list, computer usable program code configured to integrate the approval or unapproval from the approver not on the approver list into the approval process, and computer usable program code configured to indicate to a user that the approval process is complete, otherwise repeat the steps of notify and receive for the remaining approvers in the approver list.

### BRIEF DESCRIPTION OF THE SEVERAL VIEWS OF THE DRAWINGS

FIG. 1 illustrates an exemplary network architecture, in accordance with one embodiment;

FIG. 2 illustrates a representative hardware environment that may be associated with the servers and/or clients of FIG. 1, in accordance with one embodiment; and

FIG. 3 is a flowchart showing an exemplary method of a dynamic review and approval process in accordance with an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

In one general embodiment, a method includes determining a minimum approval limit and constructing an approver list for procurement of one of goods and services. The approver list comprises a plurality of approvers, each approver having an approval limit that at least meets the minimum approval limit, and removing one or more approvers from the approver list who are unavailable and utilizing delegates for unavailable approvers. Processing approvals comprises notifying a first approver from the approver list of the need for review and approval, receiving an approval or unapproval from the first approver, and repeating the steps of notifying and receiving for the remaining approvers on the approver list. An approval or unapproval from an approver not on the approver list is received and it is determined if the approval process is complete. If the approval process is complete, then indicating to a user that the approval process is complete, otherwise repeating the steps of notifying and receiving for the remaining approvers on the approver list.

In another general embodiment a non-transitory computer program product comprises a computer usable medium having computer usable program code embodied therewith. The computer usable program code comprises computer usable program code configured to receive and process an approval request for procurement of one of goods and services. The computer usable program code comprises computer usable program code configured to determine a minimum approval limit, computer usable program code configured to construct an initial approver list. The approver list comprises a plurality of approvers, with each approver having an approval limit that at least meets the minimum approval limit. The computer usable program code further comprises computer usable program code configured to determine availability of approvers on the approver list and utilize delegates for unavailable approvers and computer usable program code configured to process approvals. The computer usable program code configured to process approvals comprises computer usable program code configured to notify a first approver from the approver list of the need for review and approval, computer usable program code configured to receive an approval or unapproval from the first approver, and computer usable program code configured to repeat the steps of notify and receive for the remaining approvers in the approver list. The computer usable program code further comprises computer usable program code configured to receive an approval or unapproval from an approver not on the approver list, computer usable program code configured to integrate the approval or unapproval from the approver not on the approver list into the approval process, and computer usable program code configured to indicate to a user that the approval process is complete, otherwise repeat the steps of notify and receive for the remaining approvers in the approver list.

As will be appreciated by one skilled in the art, aspects of the present invention may be embodied as a system, method or non-transitory computer program product. Accordingly, aspects of the present invention may take the form of an entirely hardware embodiment, an entirely software embodiment (including firmware, resident software, micro-code, etc.) or an embodiment combining non-transitory software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transitory computer readable signal medium or a computer readable storage medium. A non-transitory computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Program code embodied on a non-transitory computer readable medium may be transmitted using any appropriate medium, including but not limited to wireless, wireline, optical fiber cable, RF, etc., or any suitable combination of the foregoing.

Non-transitory computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of describing the embodiments disclosed herein, two elements are considered to be coupled when one element is able to send an electrical signal to another element. The electrical signal may represent, for example but not limited to, data, operating commands, status information, or electrical power, or any combination of these electrical signals. A coupling may be implemented by wired or wireless connection means.

As illustrated in the Figures, there is shown generally at 100, an exemplary embodiment of a system for a dynamic review and approval processes for acquiring approvals for procurement of goods and services in a business environment. In a general embodiment of the system 100 may include more than one network 102, and in some embodiments may include a plurality of networks 102. In the embodiments, each network 102 may take any form including, but not limited to a local area network (LAN), a wireless network, or a wide area network (WAN) such as the Internet, peer-to-peer network, etc. Additionally, the network 102 may comprise both LAN and WAN networks, where the WAN provides connectivity between remotely located LAN networks 102.

Servers 104 are coupled to the networks 102, which enables communication between servers 104. Also coupled to the networks 102 and the servers 104 are a plurality of clients 106. Such servers 104 and/or clients 106 may each include a desktop computer, lap-top computer, hand-held computer such as a smartphone, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

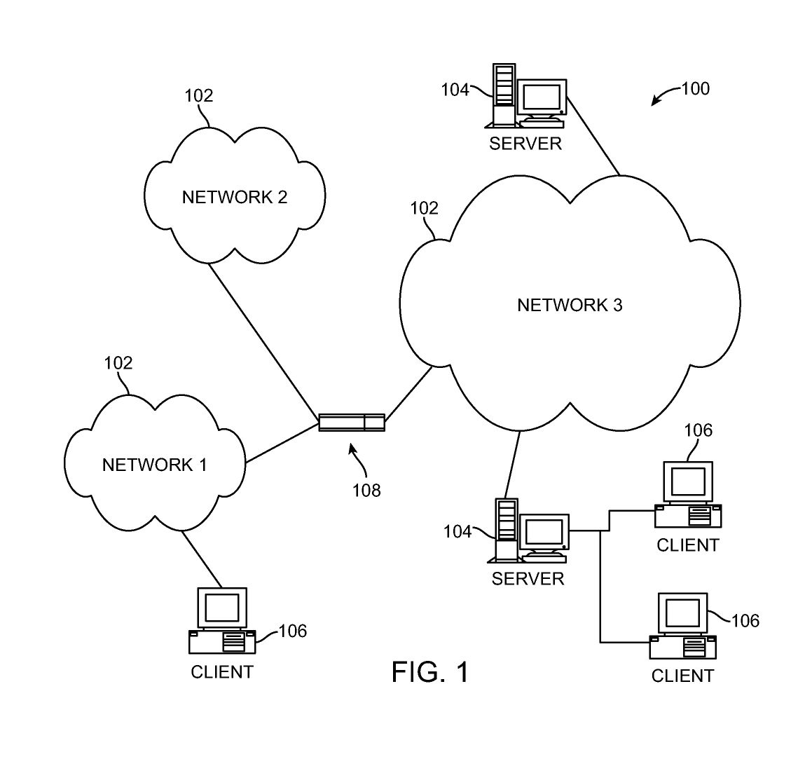

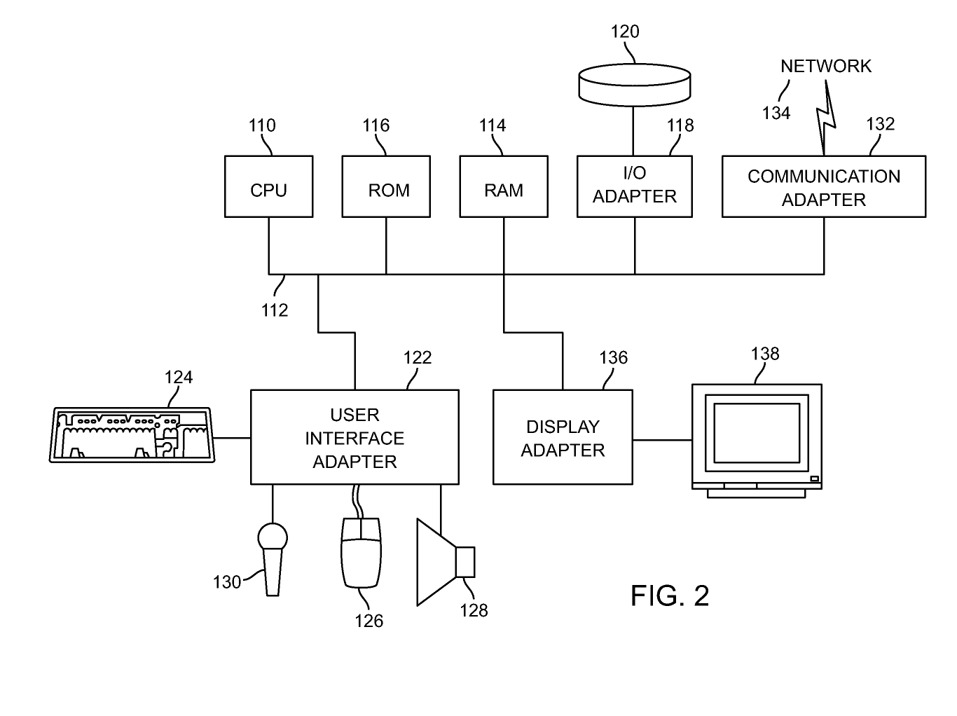

FIG. 2 illustrates an exemplary hardware environment that may be associated with the servers 104 and/or clients 106 of FIG. 1, in accordance with one embodiment. The servers 104 and/or clients 106 may each typically comprise a hardware configuration of a workstation in accordance with one embodiment having a central processing unit 110, such as a microprocessor, and a number of other units interconnected via a system bus 112.

In some embodiments, the workstation shown in FIG. 2 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 130, and/or other user interface devices such as a touch screen (not shown) to the bus 112, communication adapter 132 for connecting the workstation to a communication network 134 (e.g., a data processing network) and a display adapter 136 for connecting the bus 112 to a display device 138.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. The embodiments set forth herein may be implemented utilizing hardware, software, or any desired combination thereof. For that matter, any type of logic may be utilized which is capable of implementing the various functionality set forth herein.

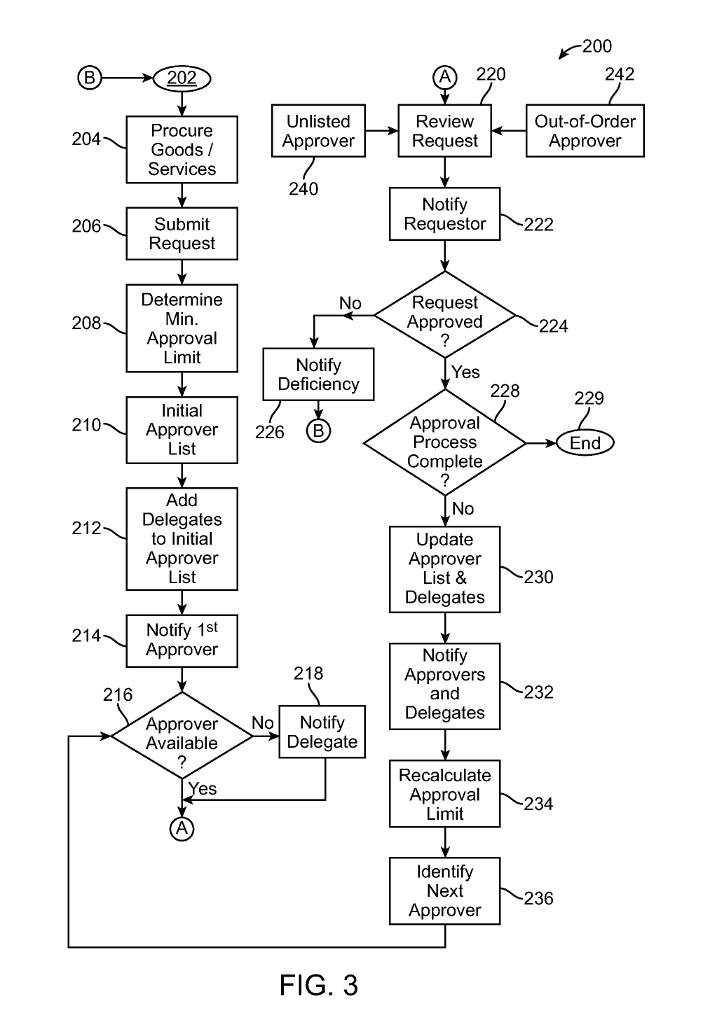

FIG. 3 illustrates an exemplary method, shown generally at 200 of a dynamic review and approval processes for acquiring approvals for procurement of goods and services. As an option, the method 200 may be carried out in the context of the architecture and environment of FIG. 1 and/or FIG. 2. However, the method 200 may be carried out in any desired environment.

The method 200 commences in start block 202. In operation 204 a business desires to procure at least one of goods and services. A person or other entity, such a buyer in a company or purchasing department in a corporation is tasked with procuring either goods or services, or both for the company or corporation. Company and corporation are referred to interchangeably hereinafter as “business.” The goods and/or services may be project specific, such as a building project or an occasional project, such as a communications systems upgrade or maintenance, or hiring additional staff. To procure the goods and/or services the business entity, hereinafter “requestor” for sake of clarity, submits a request for approval of procurement of the desired goods and/or services at operation 206. The request for procurement of goods and/or services is referred to hereinafter as “procurement request” for ease of discussion.

The procurement request typically requires approval from several different individuals and/or entities within the business, referred to hereinafter as “approvers.” Approvers consider several factors well known to business when determining to approve or not approve a procurement request. Some of these factors can include, but are not limited to, the goods and/or services themselves, the costs associated with procuring the goods and/or services, value added to the business, corporate structure, including the business's different departments and functional areas, among a plurality of other procurement considerations and factors known to business.

In operation 208, some or all of these factors, as well as other factors not particularly referred to, are considered for determining a minimum approval limit. For ease of discussion only, the minimum approval limit comprises some arbitrary financial figure. The minimum approval limit obviates the need for approvals from approvers with an approval limit less than the minimum approval limit required by the procurement request. In optional embodiments, a maximum approval limit may also be determined. The maximum approval limit would obviate the need for approvals from approvers with an approval limit greater than a maximum monetary amount required by the procurement request.

Upon determining the minimum approval limit, and optionally maximum approval limit, an initial approver list is created in operation 210. In the embodiments, the initial approver list comprises more than one approver, and may comprise a plurality of approvers, with each approver having an approval limit that at least meets the minimum approval limit. In exemplary embodiments, the initial approver list is ordered by each approver's monetary approval limit, where each successive approver on the approver list has an approval limit greater than the preceding approver. The approval limit of each approver may be determined by the business structure and goods and/or services being procured, among a plurality of other well-known procurement considerations. Additionally, an approver may have a relatively high approval limit relative to procuring certain goods and/or services, and a relatively low approval limit relative to procuring other goods and/or services. In the embodiments, the initial approver list is created such that each approver on the list has an approval limit at least equal to or greater than the requestor.

In addition to meeting the minimum approval limit, the initial approver list may be constructed based upon the procurement request, logistics associated with procuring the goods and/or services, and corporate structure, area of expertise, and the business's different departments and functional areas, among a plurality of other well-known considerations and factors. Additionally, approvers may be added or deleted from the initial approver list, due to availability and other factors.

In operation 212, delegates are added to the initial approver list. As with approvers, delegates comprise individuals or entities within the business, with an approval limit that at least meets the minimum approval limit. In addition to meeting the minimum approval limit, delegates have an approval limit greater than or equal the approver for which they delegate. Delegates may be selected by the approver for which they are a delegate, or by another entity within the business, and meet the same criteria of the approver for which they delegate. Additionally, delegates may be added or deleted due to various circumstances, such as those discussed above in reference with approvers. In optional embodiments, more than one delegate may be selected for each approver. Thus, if an approver is unavailable, and the approver's first delegate is also unavailable, a next delegate for the first approver may be notified of the need for their review and approval of the procurement request.

Once the initial approver list is generated and delegates have been selected, the method 200 continues to operation 214, where a first approver is notified of the need for their review of the procurement request. The first approver may be notified using any available means including telephonically, email, videoconferencing, other communication means, or combinations thereof. In operation 216, it is determined if the first approver is unavailable. If the first approver is unavailable, the method 200 continues to operation 218 where approver's delegate is notified of the need for their review and approval. Upon determining the availability of the first approver and notifying the first approver, or their delegate, the method 200 continues to operation 220.

In operation 220 the procurement request is reviewed and the requestor is notified of the approval or unapproval of the procurement request, in operation 222. In optional embodiments, in addition to notifying the requestor, other entities within the business, as well as approvers and delegates on the approver list, may be notified of the approval or unapproval of the procurement request. In operation 224, if the procurement request is not be approved, the method 200 continues to operation 226, where the requestor is notified of at least one deficiency as to why the procurement request was not approved. The procurement request may not be approved for one or more deficiencies common to business including clerical errors, budgetary issues, developmental issues, among numerous other well-known deficiencies. If the procurement request is not approved, any deficiencies may be noted to the requestor, and the method 200 returns to start block 202.

Returning to operation 224, if the request was approved, the method 200 continues to operation 228, where it is determined if the approval process is complete. If the approval process is complete, the approval process end in operation 229. If the approval process is not complete, the availability of approvers on the approver list is determined and the approver list is updated in operation 230. An updated approver list is generated to indicate available approvers and delegates for unavailable approvers. In operation 232 available approvers and delegates may be notified the procurement request is not complete that their review and approval or unapproval of the procurement request may still be required.

The minimum approval limit is recalculated in operation 234. In exemplary embodiments, the minimum approval limit is increased monetarily, such that a next approver on the approver list has a minimum approval limit greater than or equal to any preceding approvers. Similarly, a delegate for the next approver has a minimum approval limit greater than or equal the approver for which they delegate. A next approver on the approver list is identified in operation 236 and the method 200 returns to operation 216, where it is determined if the next approver is unavailable. If the next approver is unavailable, the method 200 continues to operation 218 where approver's delegate is notified of the need for their review and approval. Upon determining the availability of the first approver and notifying the first approver, or their delegate, the method 200 continues to operation 220.

The method 200 continues until an approver or delegate on the approver list does not approve the procurement request, such as when noted deficiencies cannot be overcome. Alternatively, the method 200 continues until the requestor, and thus procurement request, receives either receives approval from each approver, or delegate, on the approver list, or meets or exceeds the maximum approval limit, or a combination thereof, or the procurement request is otherwise granted. The method then ends in operation 230.

In the embodiments, an approver not on the approver list may submit an approval or unapproval for the procurement request at any time during the approval process. In exemplary embodiments, an approver not on the approver list, referred to herein as “unlisted approver” has an approval limit that at least meets the minimum approval limit and, in some embodiments, has a maximum approval limit greater or equal to the maximum monetary amount required by the procurement request. Preferably, the unlisted approver has an approval limit equal to or greater than approval limit of the approver currently reviewing the procurement request.

In the method 200, in operation 240 an unlisted approver reviews the procurement request and the requestor is notified of the approval or unapproval of the procurement request from the unlisted approver, in operation 222. In optional embodiments, in addition to notifying the requestor, other entities within the business, as well as approvers and delegates on the approver list, may be notified of the approval or unapproval of the procurement request by the unlisted approver. The method 200 then continues to operation 224. Allowing unlisted approvers to review the procurement request and submit their approval or unapproval in order to allow approvers inadvertently excluded from the approver list to review and submit their approval or unapproval of the procurement request. This may expedite the approval process for business. In some embodiments, allowing unlisted approvers to review the procurement request and submit their approval or unapproval or unapproval may provide improved reviews, where the unlisted approver has enhanced knowledge of, or experience with, the goods and/or services of the procurement request. Further, allowing unlisted approvers to review the procurement request and submit their approval or unapproval may expedite the approval process.

In the embodiments, an approver on approver list may submit an approval or unapproval for the procurement request, prior to being identified as a next approver, and thus, submit approval or unapproval for the procurement request out-of-order. In exemplary embodiments, an approver has an approval limit equal to or greater than approval limit of the approver currently reviewing the procurement request may submit. Preferably, the approver has an approval limit greater than approval limit of the approver currently reviewing the procurement request. The approver reviews the procurement request and then notifies the requestor of their approval or unapproval of the procurement request. Allowing approvers to review the procurement request out-of-order and submit an out-of-order approval or unapproval of the procurement request may facilitate the approval process. In exemplary embodiments, allowing approvers to review the procurement request out-of-order and submit an out-of-order approval or unapproval of the procurement request may expedite the approval process.

In the method 200, in operation 240 an approver having an approval limit equal to or greater than approval limit of a next approver reviewing the procurement request reviews the procurement request. The reviewer then submits their out-of-order review and the requestor is notified of the approval or unapproval of the procurement request. The method 200 then continues to operation 224.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

What is claimed is:

1. A method comprising:
determining a minimum approval limit;
constructing an approver list for procurement of one of goods and services, the approver list comprising a plurality of approvers, each approver having an approval limit that at least meets the minimum approval limit;
removing from the approver list one or more approvers who are unavailable and utilizing delegates for unavailable approvers;
processing approvals comprising:
notifying a first approver from the approver list of the need for review and approval;
receiving an approval or unapproval from the first approver;
repeating the steps of notifying and receiving for the remaining approvers on the approver list;
receiving an approval or unapproval from an approver not on the approver list;
determining if the approval process is complete; and
if the approval process is complete, then indicating to a user that the approval process is complete, otherwise repeating the steps of notifying and receiving for the remaining approvers on the approver list.

2. The method of claim 1, further comprising:
adding additional approvers to the approver list.

3. The method of claim 1, further comprising:
notifying the delegate of an unavailable approver of the need for review and approval;
receiving an approval or unapproval from the delegate; and
repeating the steps of notifying and receiving for the remaining approvers in the approver list.

4. The method of claim 1, further comprising:
integrating the approval or unapproval from the approver not on the approver list into the approval process;
determining if the approval process is complete; and
if the approval process is complete, then indicating to the user that the approval process is complete, otherwise repeating the steps of notifying and receiving for the remaining approvers on the approver list.

5. The method of claim 4, further comprising:
adding approvers not on the approver list to the approver list.

6. The method of claim 1, further comprising:
wherein the approver list is ordered; and
wherein each approver is higher in order than a preceding approver.

7. The method of claim 6, wherein the approver list is ordered monetarily.

8. The method of claim 6, further comprising:
receiving an approval or unapproval from an out-of-order approver;
integrating the approval or unapproval from the out-of-order approver into the approval process;
determining if the approval process is complete; and
if the approval process is complete, then indicating to the user that the approval process is complete, otherwise repeating the steps of notifying and receiving for the remaining approvers on the approver list.

9. A non-transitory computer program product comprising:
a computer usable medium having computer usable program code embodied therewith, the computer usable program code comprising:
computer usable program code configured to receive and process an approval request for procurement of one of goods and services, the computer usable program code comprising:
computer usable program code configured to determine a minimum approval limit;
computer usable program code configured to construct an initial approver list, the approver list comprising a plurality of approvers, each approver having an approval limit that at least meets the minimum approval limit;
computer usable program code configured to determine availability of approvers on the approver list and utilize delegates for unavailable approvers;
computer usable program code configured to process approvals comprising:
computer usable program code configured to notify a first approver from the approver list of the need for review and approval;
computer usable program code configured to receive an approval or unapproval from the first approver;
computer usable program code configured to repeat the steps of notify and receive for the remaining approvers in the approver list;
computer usable program code configured to receive an approval or unapproval from an approver not on the approver list;
computer usable program code configured to integrate the approval or unapproval from the approver not on the approver list into the approval process; and
computer usable program code configured to indicate to a user that the approval process is complete, otherwise repeat the steps of notify and receive for the remaining approvers in the approver list.

10. The non-transitory computer program product of claim 9, further comprising:
computer usable program code configured to order approvers on the initial approver list monetarily.

11. The non-transitory computer program product of claim 9, further comprising:
computer usable program code configured to order approvers on the initial approver list by their minimum approval limit.

12. The non-transitory computer program product of claim 9, further comprising:
computer usable program code configured to notify a delegate of an unavailable approver of the need for review and approval;
computer usable program code configured to receive an approval or unapproval from the delegate; and
computer usable program code configured to indicate to a user that the approval process is complete, otherwise repeat the steps of notify and receive for the remaining approvers on the approver list.

13. The non-transitory computer program product of claim 10, further comprising:
computer usable program code configured to receive an approval or unapproval from an out-of-order approver;
computer usable program code configured to integrate the approval or unapproval from the out-of-order approver into the approval process; and
computer usable program code configured to indicate to a user that the approval process is complete, otherwise repeat the steps of notify and receive for the remaining approvers on the approver list.

14. The non-transitory computer program product of claim 9, further comprising:
computer usable program code configured to add approvers not on the approver list to the approver list.

15. The non-transitory computer program product of claim 9, further comprising:
computer usable program code configured to restart the approval process if an approver did not approve the request.
